(19) United States
(12) Patent Application Publication
(10) Pub. No.: US 2024/0154213 A1
(43) Pub. Date: May 9, 2024

(54) POWER STORAGE CELL

(71) Applicant: TOYOTA JIDOSHA KABUSHIKI KAISHA, Toyota-shi (JP)

(72) Inventors: Satomi YAMAMOTO, Miyoshi-shi (JP); Masayoshi HAGA, Nagoya-shi (JP); Masashi CHIHARA, Nagoya-shi (JP); Takenori IKEDA, Owariasahi-shi (JP); Nana KURASHITA, Toyata-shi (JP)

(73) Assignee: TOYOTA JIDOSHA KABUSHIKI KAISHA, Toyota-shi (JP)

(21) Appl. No.: 18/500,433

(22) Filed: Nov. 2, 2023

(30) Foreign Application Priority Data
Nov. 4, 2022 (JP) 2022-177329

(51) Int. Cl. H01M 50/103; H01M 50/15

(52) U.S. Cl. CPC H01M 50/103; H01M 50/15

(57) ABSTRACT

A power storage cell includes an electrode assembly, a cell case, and an external terminal. The cell case has a case main body and a lid. The lid has a lid main body, and an inversion plate that is able to short-circuit the lid main body and the external terminal. The inversion plate has: a base portion; an inversion portion connected to inside of the base portion, the inversion portion being able to come into contact with the external terminal; and a low-elastic member made of a conductive material having an elastic modulus smaller than an elastic modulus of the inversion portion, the low-elastic member being provided on a surface of the inversion portion facing the external terminal. The low-elastic member is elastically deformed with the low-elastic member being sandwiched between the inversion portion and the external terminal when the inversion portion is inverted.

This nonprovisional application is based on Japanese Patent Application No. 2022-177329 filed on Nov. 4, 2022 with the Japan Patent Office, the entire contents of which are hereby incorporated by reference.

### BACKGROUND

### Field

The present disclosure relates to a power storage cell.

### Description of the Background Art

Japanese Patent Application Laid-Open No. 2017-174732 discloses a power storage cell including an electrode assembly and a case for housing the electrode assembly. The case includes a main body and a lid portion fixed to the main body. An inversion plate is connected to the lid. The lid portion is electrically connected to the external terminal of the positive electrode, and the inversion plate is electrically connected to the lid portion. A current-carrying plate electrically connected to the external terminal of the negative electrode is disposed above the inversion plate.

When the inversion plate is inverted in the power storage cell, the inversion plate comes into contact with the conducting plate. Then, since the external terminal of the positive electrode and the external terminal of the negative electrode are short-circuited through the conducting plate, the inversion plate, and the lid portion, a short-circuit current flows through the inversion plate.

### SUMMARY

In the power storage cell described in Japanese Patent Application Laid-Open No. 2017-174732, there is a concern that when a contact area between the inversion plate and the conductive plate is small, the inversion plate may generate heat.

It is an object of the present disclosure to provide a power storage cell to suppress heat generation of an inversion plate.

A power storage cell according to an aspect of the present disclosure includes: an electrode assembly; a cell case that accommodates the electrode assembly; and an external terminal fixed to an upper surface of the cell case, wherein the cell case has a case main body that accommodates the electrode assembly, the case main body being provided with an opening that opens upward, and a lid connected to the case main body so as to close the opening of the case main body, the lid has a lid main body connected to the opening of the case main body and charged positively or negatively in the electrode assembly, and an inversion plate connected to the lid main body, the inversion plate being able to short-circuit the lid main body and the external terminal, the inversion plate has a base portion connected to a portion of the lid main body located below the external terminal, the base portion being formed to have an annular shape, an inversion portion connected to inside of the base portion, the inversion portion being able to come into contact with the external terminal, and a low-elastic member made of a conductive material having an elastic modulus smaller than an elastic modulus of the inversion portion, the low-elastic member being provided on a surface of the inversion portion facing the external terminal, and the low-elastic member is elastically deformed with the low-elastic member being sandwiched between the inversion portion and the external terminal when the inversion portion is inverted.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a power storage cell according to an embodiment of the present disclosure.

FIG. 2 is an exploded perspective view of the power storage cell shown in FIG. 1.

FIG. 3 is a cross-sectional view of the power storage cell shown in FIG. 1.

FIG. 4 is an enlarged cross-sectional view of the vicinity of an inversion plate.

FIG. 5 is a cross-sectional view schematically showing a state after an operation of the inversion plate.

### DESCRIPTION OF THE PREFERRED EMBODIMENTS

Embodiments of the present disclosure will be described with reference to the drawings. In the drawings referred to below, the same or corresponding members are denoted by the same reference numerals.

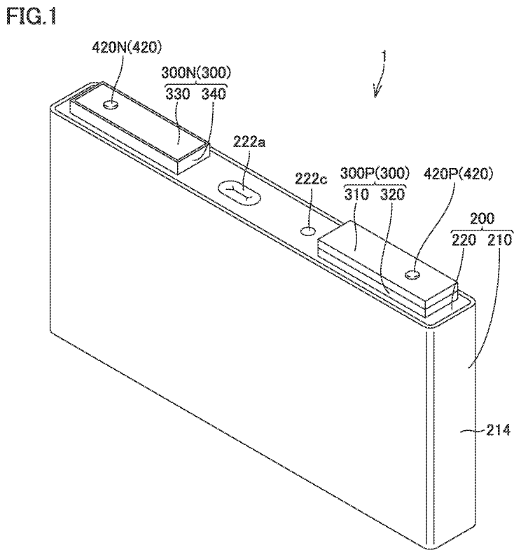

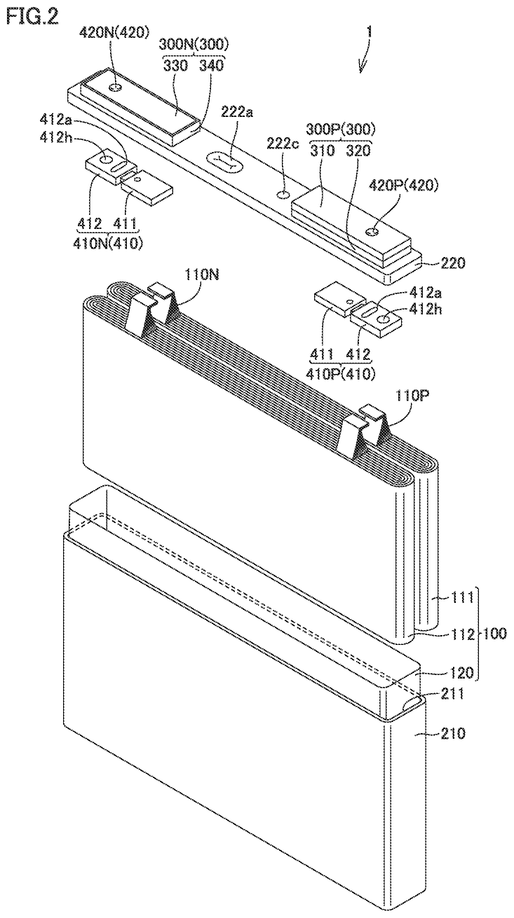

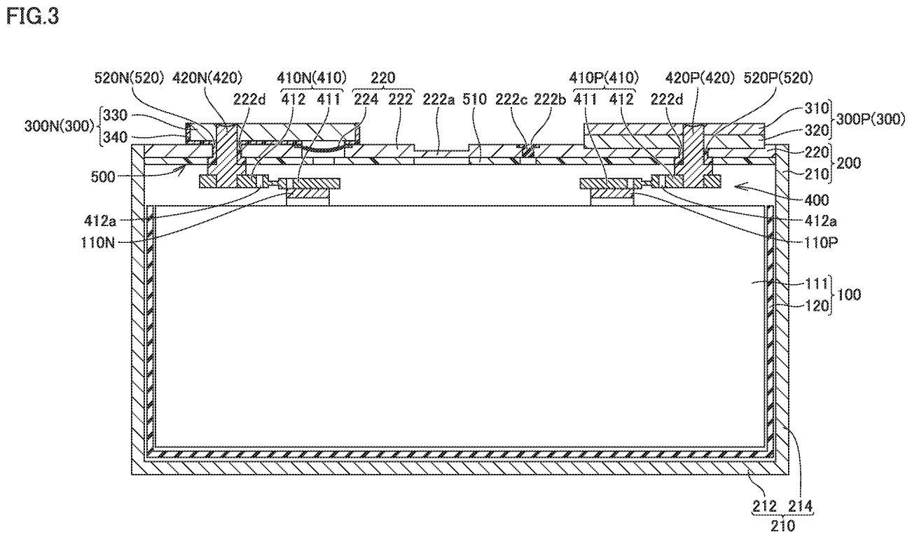

FIG. 1 is a perspective view schematically showing a power storage cell according to an embodiment of the present disclosure. FIG. 2 is an exploded perspective view of the power storage cell shown in FIG. 1. FIG. 3 is a cross-sectional view of the power storage cell shown in FIG. 1.

As shown in FIGS. 1 to 3, the power storage cell 1 includes an electrode assembly 100, a cell case 200, external terminals 300, a coupling member 400, and an insulating member 500.

The electrode assembly 100 includes a plurality of unit electrode assemblies 111, 112 and an insulating film 120. In the present embodiment, the plurality of unit electrode assemblies includes two unit electrode assemblies 111 and 112. Each of the unit electrode assemblies 111 and 112 includes a plurality of tabs, that is, a plurality of positive electrode tabs 110P and a plurality of negative electrode tabs 110N. The unit electrode assemblies 111 and 112 have the same structure. Therefore, the unit electrode assembly 111 will be described below.

The unit electrode assembly 111 includes a positive electrode sheet, a separator, and a negative electrode sheet. The positive electrode sheet, the negative electrode sheet, and the separator are formed in a long rectangular shape.

The positive electrode sheet includes a metal foil and a positive electrode composite layer provided on the metal foil. An uncoated portion in which a positive electrode composite layer is not formed is formed in the upper long side portion of the metal foil, and the plurality of positive electrode tabs 110P are formed at intervals in the uncoated portion.

The negative electrode sheet includes a metal foil and a negative electrode composite layer formed on the metal foil. An uncoated portion in which the negative electrode composite layer is not formed is formed in the upper long side portion of the metal foil, and the plurality of negative electrode tabs 110N are formed at intervals in the uncoated portion.

In a state in which each sheet is wound, each positive electrode tab 110P is arranged in the thickness direction (a direction orthogonal to the sheet of FIG. 3) and each negative electrode tab 110N is arranged in the thickness direction. The positive electrode tab 110P and the negative electrode tab 110N are arranged at intervals in the width direction (direction orthogonal to both the thickness direction and the height direction).

The insulating film 120 has a shape that collectively covers the peripheral surface and the bottom surface of the plurality of unit electrode assemblies 111 and 112.

The cell case 200 houses the electrode assembly 100. The cell case 200 contains an electrolyte solution (not shown). The cell case 200 is sealed. The cell case 200 includes a case main body 210 and a lid 220.

The case main body 210 has an opening 211 that opens upward. The case main body 210 is made of metal such as aluminum. The case main body 210 includes a bottom wall 212 and a peripheral wall 214. The bottom wall 212 is formed in a rectangular and flat plate shape. The peripheral wall 214 rises from the bottom wall 212. The peripheral wall 214 is formed in a quadrangular cylindrical shape. The length of the peripheral wall 214 in the width direction is longer than the length of the peripheral wall 214 in the thickness direction. The length of the peripheral wall 214 in the height direction is longer than the length of the peripheral wall 214 in the thickness direction.

The lid 220 closes the opening 211 of the case main body 210. The lid 220 is connected to the opening 211 by welding or the like. The lid 220 is formed in a flat plate shape. The lid 220 is made of metal such as aluminum. The lid 220 includes a lid main body 222 and an inversion plate 224.

The lid main body 222 is connected to the case main body 210 by welding or the like. The lid main body 222 is formed with a pressure release valve 222a, a liquid injection hole 222b, a sealing member 222c, and a pair of pin insertion holes 222d.

The pressure release valve 222a is formed at the center of the lid main body 222. The pressure release valve 222a is formed so as to break when the internal pressure of the cell case 200 becomes equal to or higher than a predetermined pressure. When the pressure release valve 222a breaks, the gas in the cell case 200 is released to the outside of the cell case 200 through the pressure release valve 222a, so that the internal pressure of the cell case 200 decreases.

The liquid injection hole 222b is a through hole for injecting the electrolyte solution into the cell case 200 in the manufacturing process of the power storage cell 1. The sealing member 222c seals the liquid injection hole 222b. After the electrolyte solution is injected into the case main body 210, the liquid injection hole 222b is sealed by the sealing member 222c.

The pair of pin insertion holes 222d are formed at intervals in the width direction. Each pin insertion hole 222d is a through hole through which a coupling pin 420 described later is inserted.

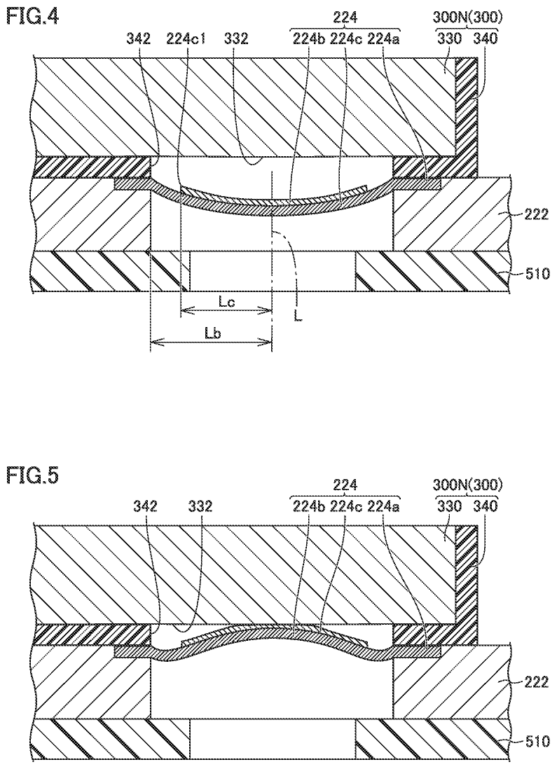

The inversion plate 224 is connected to the lid main body 222 by welding or the like. The inversion plate 224 can short-circuit the lid main body 222 and the external terminal 300. As shown in FIG. 4, the inversion plate 224 includes a base portion 224a, an inversion portion 224b, and a low-elastic member 224c.

The base portion 224a is connected to the lid main body 222 by welding or the like. In the present embodiment, the base portion 224a is connected to a portion of the lid main body 222 located below the negative electrode terminal plate 330 described later. The base portion 224a is formed in an annular shape, more specifically, in an annular shape.

The inversion portion 224b is connected to the inside of the base portion 224a. As shown in FIG. 4, when the internal pressure of the cell case 200 is lower than a predetermined pressure (normal time), the inversion portion 224b is curved so as to be convex from the outside of the lid main body 222 toward the inside (lower side in FIG. 4). When the internal pressure of the cell case 200 becomes equal to or higher than a predetermined pressure, as shown in FIG. 5, the inversion portion 224b is deformed into a shape curved so as to be convex from the inside of the cell case 200 toward the outside (the upper side in FIG. 4). The inversion portion 224b is made of aluminum, iron, or the like.

The low-elastic member 224c is made of a conductive material having an elastic modulus smaller than that of the inversion portion 224b. The low-elastic member 224c is provided on a surface (upper surface in FIG. 4) of the inversion portion 224b facing the negative electrode terminal plate 330. The low-elastic member 224c is elastically deformed by being sandwiched between the inversion portion 224b and the negative electrode terminal plate 330 when the inversion portion 224b is inverted. The low-elastic member 224c is made of, for example, tin plating, conductive rubber, or conductive resin. The thickness of the low-elastic member 224c may be equal to or smaller than the thickness of the inversion portion 224b, or may be larger than the thickness of the inversion portion 224b. For example, the thickness of the low-elastic member 224c is set to about 5 μm to 500 μm.

As shown in FIG. 4, the length Lc from the edge 224c1 of the low-elastic member 224c to the central axis L of the inversion portion 224b may be set to half or more of the length Lb from the edge of the inversion portion 224b to the central axis L in the width direction.

The external terminal 300 is fixed to the upper surface of the cell case 200. A bus bar (not shown) is connected to the external terminal 300 by welding or the like. The external terminal 300 includes a positive electrode member 300P and a negative electrode member 300N.

The positive electrode member 300P is connected to the upper surface of the cell case 200 by welding or the like. The positive electrode member 300P includes a positive electrode terminal plate 310 and a terminal block 320.

The positive electrode terminal plate 310 is formed in a rectangular parallelepiped shape. The positive electrode terminal plate 310 is made of a metal such as aluminum.

The terminal block 320 is formed in a rectangular parallelepiped shape. The terminal block 320 is made of a metal (e.g., iron) different from the metal constituting the positive electrode terminal plate 310. The terminal block 320 is connected to the upper surface of the lid main body 222 by welding, and the positive electrode terminal plate 310 is connected to the upper surface of the terminal block 320 by welding or the like. That is, the case main body 210 and the lid 220 are electrically connected to the positive electrode terminal plate 310 via the terminal block 320, and are charged to the same polarity as the positive electrode terminal plate 310. Each of the positive electrode terminal plate 310 and the terminal block 320 is formed with a through hole through which a positive electrode coupling pin 420P described later is inserted.

The negative electrode member 300N is connected to the upper surface of the cell case 200 by welding or the like. The negative electrode member 300N is spaced apart from the positive electrode member 300P in the width direction. The negative electrode member 300N includes a negative electrode terminal plate 330 and an insulating plate 340.

The negative electrode terminal plate 330 is formed in a substantially rectangular parallelepiped shape. The negative electrode terminal plate 330 is disposed above the inversion plate 224. As shown in FIG. 4, the negative electrode terminal plate 330 has an opposing portion 332 opposed to the inversion plate 224. The opposing portion 332 is formed flat. As described above, when the internal pressure of the cell case 200 is lower than the predetermined pressure (normal time), the inversion portion 224b of the inversion plate 224 is separated from the opposing portion 332, and when the internal pressure of the cell case 200 is equal to or higher than the predetermined pressure, the inversion portion 224b is deformed to be convex toward the opposing portion 332. Thereby, the low-elastic member 224c comes into contact with the opposing portion 332.

The insulating plate 340 is fixed to the upper surface of the lid 220. The insulating plate 340 holds the negative electrode terminal plate 330. The insulating plate 340 insulates the lid 220 from the negative electrode terminal plate 330. Each of the negative electrode terminal plate 330 and the insulating plate 340 is formed with a through hole through which a negative electrode coupling pin 420N described later is inserted. As shown in FIGS. 3 and 4, the insulating plate 340 has an exposure port 342 for exposing the opposing portion 332.

The coupling member 400 connects the plurality of tabs 110P and 110N to the external terminal 300. The coupling member 400 includes a current collector plate 410 and a coupling pin 420.

The current collector plate 410 is connected to a plurality of tabs. The current collector plate 410 includes a positive electrode current collector plate 410P and a negative electrode current collector plate 410N.

The positive electrode current collector plate 410P is connected to a plurality of positive electrode tabs 110P by welding or the like. The positive electrode current collector plate 410P includes a first flat plate portion 411 and a second flat plate portion 412.

A plurality of positive electrode tabs 110P are connected to the first flat plate portion 411 by ultrasonic welding or the like. A through hole is formed in the first flat plate portion 411. The plurality of positive electrode tabs 110P are connected to the lower surface of the first flat plate portion 411. However, the plurality of positive electrode tabs 110P may be connected to the upper surface of the first flat plate portion 411.

The second flat plate portion 412 is disposed outside the first flat plate portion 411 in the width direction. A coupling hole 412h and a fuse portion 412a are formed in the second flat plate portion 412. The fuse portion 412a is formed by a through hole penetrating the second flat plate portion 412 in the thickness direction. As shown in FIG. 3, a thin portion may be formed between the second flat plate portion 412 and the first flat plate portion 411.

The negative electrode current collector plate 410N is connected to a plurality of negative electrode tabs 110N by welding or the like. The configuration of the negative electrode current collector plate 410N is substantially the same as the configuration of the positive electrode current collector plate 410P.

The coupling pin 420 connects the current collector plate 410 and the external terminal 300. The coupling pin 420 includes a positive electrode coupling pin 420P and a negative electrode coupling pin 420N.

The positive electrode coupling pin 420P connects the positive electrode current collector plate 410P and the positive electrode terminal plate 310. The positive electrode coupling pin 420P is formed in a cylindrical shape. The lower end portion of the positive electrode coupling pin 420P is connected to the second flat plate portion 412 in a state of being inserted into the coupling hole 412h. The upper end of the positive electrode coupling pin 420P is caulked to the positive electrode terminal plate 310.

The negative electrode coupling pin 420N connects the negative electrode current collector plate 410N and the negative electrode terminal plate 330. The negative electrode coupling pin 420N is formed in a cylindrical shape. The lower end portion of the negative electrode coupling pin 420N is connected to the second flat plate portion 412 in a state of being inserted into the coupling hole 412h. The upper end of the negative electrode coupling pin 420N is caulked to the negative electrode terminal plate 330.

The insulating member 500 insulates the coupling member 400 from the cell case 200. The insulating member 500 includes an insulating sheet 510 and an insulator 520.

The insulating sheet 510 is connected to the lower surface of the lid main body 222. A through hole is formed in a portion of the insulating sheet 510 which overlaps the pressure release valve 222a in the height direction, a portion which overlaps the liquid injection hole 222b, a portion which overlaps the pin insertion hole 222d, and a portion which overlaps the inversion plate 224.

The insulator 520 has a shape surrounding the coupling pin 420, and insulates the coupling pin 420 from the cell case 200. The insulator 520 includes a positive electrode side insulator 520P and a negative electrode side insulator 520N.

The positive electrode side insulator 520P covers the positive electrode coupling pin 420P. The positive electrode side insulator 520P is formed in a cylindrical shape. The positive electrode side insulator 520P insulates the positive electrode coupling pin 420P from the lid main body 222.

The negative electrode side insulator 520N covers the negative electrode coupling pin 420N. The structure of the negative electrode side insulator 520N is the same as the structure of the positive electrode side insulator 520P.

In the power storage cell 1 described above, when the internal pressure of the cell case 200 rises to the predetermined pressure or higher due to the occurrence of an abnormality or the like in the electrode assembly 100, as shown in FIG. 5, the inversion portion 224b of the inversion plate 224 is inverted (deformed into a shape curved to be convex upward), whereby the low-elastic member 224c comes into contact with the opposing portion 332 of the negative electrode terminal plate 330. Thus, since the external terminal 300, the coupling member 400, and the electrode assembly 100 form a closed circuit through the lid 220, a large current flows through the circuit. Then, the fuse portion 412a formed in the second flat plate portion 412 is fused. As a result, the electrical connection between the electrode assembly 100 and the cell case 200 is interrupted.

Here, when the inversion portion 224b is inverted, the low-elastic member 224c is elastically deformed by being sandwiched between the opposing portion 332 and the inversion portion 224b, so that the contact area between the inversion plate 224 and the negative electrode terminal plate 330 is effectively ensured. Accordingly, heat generation at the contact portion between the inversion plate 224 and the negative electrode terminal plate 330 is reduced.

It will be appreciated by those skilled in the art that the exemplary embodiments described above are specific examples of the following aspects.

### Embodiment 1

A power storage cell comprising:
an electrode assembly;
a cell case that accommodates the electrode assembly; and
an external terminal fixed to an upper surface of the cell case, wherein
the cell case has
   a case main body that accommodates the electrode assembly, the case main body being provided with an opening that opens upward, and
   a lid connected to the case main body so as to close the opening of the case main body,
the lid has
   a lid main body connected to the opening of the case main body and charged positively or negatively in the electrode assembly, and
   an inversion plate connected to the lid main body, the inversion plate being able to short-circuit the lid main body and the external terminal,
the inversion plate has
   a base portion connected to a portion of the lid main body located below the external terminal, the base portion being formed to have an annular shape,
   an inversion portion connected to inside of the base portion, the inversion portion being able to come into contact with the external terminal, and
   a low-elastic member made of a conductive material having an elastic modulus smaller than an elastic modulus of the inversion portion, the low-elastic member being provided on a surface of the inversion portion facing the external terminal, and
the low-elastic member is elastically deformed with the low-elastic member being sandwiched between the inversion portion and the external terminal when the inversion portion is inverted.

In this power storage cell, since the low elastic portion is elastically deformed when the inversion portion is inverted, a contact area between the inversion plate and the external terminal is effectively ensured. Therefore, heat generation in the inversion portion is suppressed.

### Embodiment 2

The power storage cell according to Embodiment 1, wherein the low-elastic member is made of tin plating.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage cell comprising:
an electrode assembly;
a cell case that accommodates the electrode assembly; and
an external terminal fixed to an upper surface of the cell case, wherein
the cell case has
a case main body that accommodates the electrode assembly, the case main body being provided with an opening that opens upward, and
a lid connected to the case main body so as to close the opening of the case main body,
the lid has
a lid main body connected to the opening of the case main body and charged positively or negatively in the electrode assembly, and
an inversion plate connected to the lid main body, the inversion plate being able to short-circuit the lid main body and the external terminal,
the inversion plate has
a base portion connected to a portion of the lid main body located below the external terminal, the base portion being formed to have an annular shape,
an inversion portion connected to inside of the base portion, the inversion portion being able to come into contact with the external terminal, and
a low-elastic member made of a conductive material having an elastic modulus smaller than an elastic modulus of the inversion portion, the low-elastic member being provided on a surface of the inversion portion facing the external terminal, and
the low-elastic member is elastically deformed with the low-elastic member being sandwiched between the inversion portion and the external terminal when the inversion portion is inverted.

2. The power storage cell according to claim 1, wherein the low-elastic member is made of tin plating.
